(19) United States
(12) Patent Application Publication
(10) Pub. No.: US 2014/0250975 A1
(43) Pub. Date: Sep. 11, 2014

(54) HANDHELD GAS ANALYZER WITH SENSOR ON CHIP

(71) Applicant: Michael John Kane, Portland, OR (US)

(72) Inventor: Michael John Kane, Portland, OR (US)

(21) Appl. No.: 14/197,484

(22) Filed: Mar. 5, 2014

Related U.S. Application Data
(60) Provisional application No. 61/772,745, filed on Mar. 5, 2013.

(51) Int. Cl. G01N 1/22

(52) U.S. Cl. CPC G01N 1/22
USPC 73/23.31

(57) ABSTRACT

A handheld sized combustion gas sampling analyzer having a gas sample collecting means, an in-line water trap and particulate filter, at least one removable sensor module, with each of the sensor modules adapted to receive at least one sensor chip, and circuitry adapted to receive sensing information from the sensor module and sensor chip thereon.

### CROSS-REFERENCE TO RELATED APPLICATIONS

This application claims the benefit of U.S. provisional application Ser. No. 61/772,745 filed on Mar. 5, 2013, the entirety of which is incorporated herein by reference.

### BACKGROUND OF THE INVENTION

The technical field of the invention pertains to instruments used for sampling and analyzing gases, and, more particularly, to handheld-sized combustion analyzers adapted for use by field HVAC technicians.

Existing instruments used in the HVAC industry include the Eagle and Smart Bell Plus combustion meters manufactured and distributed by UEi, the owner's and instruction manuals for which are attached herewith and are incorporated in their entireties by reference herein. The Fyrite INSIGHT combustion gas analyzer by Bacharach is another existing handheld-sized instrument. Yet another existing combustion analyzer device is the Testo 330 Flue Gas analyzer. And still other existing combustion gas analyzers include the BTU900 and BTU4400 by E Instruments.

In all of the existing devices, the CO gas sensors used require periodic calibration or sensor replacement. Although the life of the sensors used in such devices is improving over time (with improvements in the sensors being used) and in-field replacement procedures are becoming more readily available, sensor calibration and sensor performance varies widely from device to device and depend upon the gas type being sensed and the technologies of the sensors used. Different manufacturers use different sensor arrangements and technologies. Some use conventional electrochemical Oxygen and CO sensors, and others use an electro-optical CO2 sensor to eliminate the O2 sensor altogether (and, thus, eliminate the costs associated with its replacement or recalibration). Still other designs use different sensor technologies, for example catalytic (or Pellistor), non-dispersive infrared (NDIR), thermal conductivity, solid state/semiconductor, or standard/conventional electrochemical type sensors. Each different technology and each different type of gas to be sampled and measured typically requires its own unique physical structure and electronic (metering) circuitry, further complicating the tasks of HVAC field technicians.

What is needed, therefore, are new designs for gas sampling analyzers that address shortcomings of the available existing HVAC gas sampling analyzers.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 is a block diagram of a handheld-sized gas analyzer according to various embodiments.

FIG. 2 is a block diagram of a gas analyzer instrument with interchangeable sensor modules and sensor chip components, according to various embodiments.

FIG. 3A is a sensor module with sensor chip, according to various embodiments.

FIG. 3B is the sensor module in FIG. 3A with different sensor chip, according to various embodiments.

FIG. 3C is a perspective view of an exemplary sensor module with associated sensor cap, according to various embodiments.

FIG. 4 is a top view of an exemplary arrangement of sensors, according to some embodiments.

FIG. 5A is a side elevation view of the exemplary arrangement of sensors shown in FIG. 4, in various embodiments.

FIG. 5B is a perspective view of a sensor module, in various embodiments.

FIG. 6A is an illustration of an exemplary solid state type gas sensor for use with a sensor module, according to embodiments.

FIG. 6B is an illustration of an exemplary catalytic type gas sensor for use with a sensor module, according to embodiments.

FIG. 6C is an illustration of an exemplary thermal conductivity type gas sensor for use with a sensor module, according to embodiments.

FIG. 6D is an illustration of an exemplary electrochemical type gas sensor for use with a sensor module, according to embodiments.

FIG. 6E is an illustration of an exemplary non-dispersive infrared type gas sensor for use with a sensor module, according to embodiments.

### DETAILED DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

Although preferred embodiments are presented and described in the context of a handheld-sized gas sampling combustion analyzer adapted for use by HVAC field technicians, numerous separable inventive aspects are presented that may be used in a wide variety of other gas sensing applications and with the use of a wide variety of other types of test and measurement or monitoring equipment associated with various gas sensing applications. Various competitive products are available, and new products are being developed. Reference to particular models of devices herein are used to illustrate various features, shortcomings, improvement opportunities, newly discovered inventive aspects, and so forth associated with gas sensing applications, primarily in the types of applications that pertain to gas sampling and analyzing by field technicians in the HVAC industry.

Generally, gas sensors used in gas sampling combustion analyzers such as the Testo 330 and Bacharach INSIGHT devices may last four to five years before replacement is necessary. Oxygen (O2) sensors may last 4-5 years for example, before replacement is needed. Infrared (IR) sensors may last seven years or longer depending upon particular usage and other factors. Not surprisingly, gas sensors are improving in terms of life expectancy, quality, and capabilities for replacing sensors by field technicians in-the-field. Some manufacturers require users of particular instruments in particular countries to return the instrument and/or the gas sensors for replacement and/or calibration/re-calibration. Some manufacturers provide for customers in particular countries to calibrate/re-calibrate their gas sensors, and in other countries require customers of those same models of gas analyzers return the sensors to the OEM for factory replacement and/or calibration/re-calibration.

Oxygen sensors may last several years but are expensive to replace. Carbon monoxide (CO) sensors may last several years but typically require re-calibration every six months to a year, requiring the instruments using those sensors to be inoperative during the time needed to replace or calibrate/re-calibrate the sensors. Bacharach, for example, provides customers with a sensor replacement/calibration program that the customer pays for. Customers participating in such program receives a replacement sensor from Bacharach, installs the replacement sensor (potentially in-the-field), and sends the replaced sensor back to the manufacturer Bacharach for re-calibration. In the case of the Bacharach B-smart sensor replacement/re-calibration program, the field technician is potentially able to install the replacement sensor, enter codes corresponding to the replaced sensor into the device operating the replaced sensor, and continue in-field work with minimal instrument downtime. Other manufacturers such as E Instruments, for example, advertise “field replaceable, pre-calibrated sensors” and claim to use higher quality, longer-life sensors in order to minimize instrument (and technician) downtimes. Still other manufacturers, namely Universal Enterprises Inc. (UEi), lower cost of operation/cost of ownership by eliminating sensors that typically require periodic re-calibration or replacement. For example, the UEi Eagle and Smart Bell combustion analyzers utilize electro-optical sensor technology (UEi uses “EOS Technology” as a trademark) to eliminate the need for an O2 sensor by directly measuring CO2 and calculating O2 level therefrom. The use of electro-optical sensor technology replaces the use of standard/conventional electrochemical sensors that rely on a chemical reaction between the sampled gas and sensor electrode material. To further reduce cost of operation/cost of ownership, the number of sensors requiring periodic re-calibration may be minimized. For example, it is desirable to limit the sensors requiring periodic re-calibration to just the CO sensor, in a gas sampling combustion analyzer instrument.

In preferred embodiments, the gas sampling combustion analyzer instrument includes a sensor module that includes a sensor on a chip (or referred to herein as a “chip sensor” or “sensor chip”). Preferably, different sensor chips may be used in the sensor module, with the different sensor chips using different sensing technology or configured and adapted to sense a particular type of gas. In preferred embodiments, different sensor modules may be used with a handheld-sized gas sampling analyzer so as to test for and measure different types of gas depending upon the particular sensor module (or modules) installed in the analyzer instrument. For example, the field technician may have one or more sensor module configured with different sensor chips so that the technician is able to swap out the modules to test for different gases or to test and measure sampled gas using sensors of differing sensitivities, filtration levels (for instance, with and without NOx filtration associated with the CO sensor), sensor age (for example, a CO sensor held in storage versus a newly received replacement/re-calibrated sensor), and sensor technology (for example, a Pellistor (or catalytic) type sensor versus conventional electrochemical type CO sensor.

In preferred embodiments, a sensor module is configured and adapted to translate gas sensing information from one or more gas sensor to a usable form/format for receipt by the gas analyzer associated with (or containing) the sensor module, with the gas analyzer instrument including a flue gas probe or other attachment for drawing a gas sample to the analyzer, an in-line water trap and particulate filter to protect the analyzer circuitry and sensors, and conventional user interface such as a display and keypad for navigating analyzer software menus for operation of the gas analyzer.

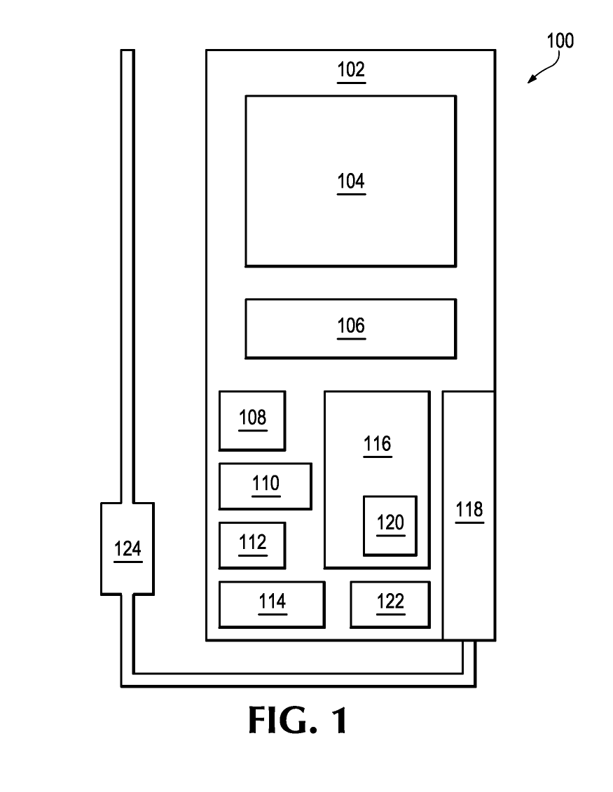

FIG. 1 shows a block diagram of a handheld-sized gas analyzer 100, according to various preferred embodiments, with the analyzer having a main handheld-sized body 102, display 104, keypad 106, microprocessor 108, internal and external device drivers 110, input/output circuitry 112, and memory 114. The analyzer is shown with a flue gas probe 124 for collecting sample gas and feeding the sampled gas through a water trap and particulate filter 118. Also preferably include, as shown, is circuitry and means for wireless communication 122 using Blue Tooth, wi-fi, Zygbee, or other wireless communication method, for receiving information from other devices and/or communication networks, and transmitting information thereto. The analyzer 100 preferably includes at least one interchangeable, removable sensor module 116 which includes therewithin a (preferably) interchangeable, removable sensor chip 120. In less preferred embodiments the handheld unit 102 includes structure to receive at least one interchangeable, removable sensor chip 120 without the sensor chip 120 first included in a sensor module 116. That is, in less preferred embodiments, the analyzer 100 includes structure for removable, replaceable sensor chips but not necessarily structure for receiving one or more sensor module 116 within which one or more sensor chip 120 is configured. Similarly, in less preferred embodiments the handheld unit (case structure) 102 includes structure for receiving one or more sensor module 116 that include (within the sensor module 116) one or more fixed, permanently integrated sensor chips that are not designed or adapted for removal and replacement by in-field technicians/users of the analyzer 100.

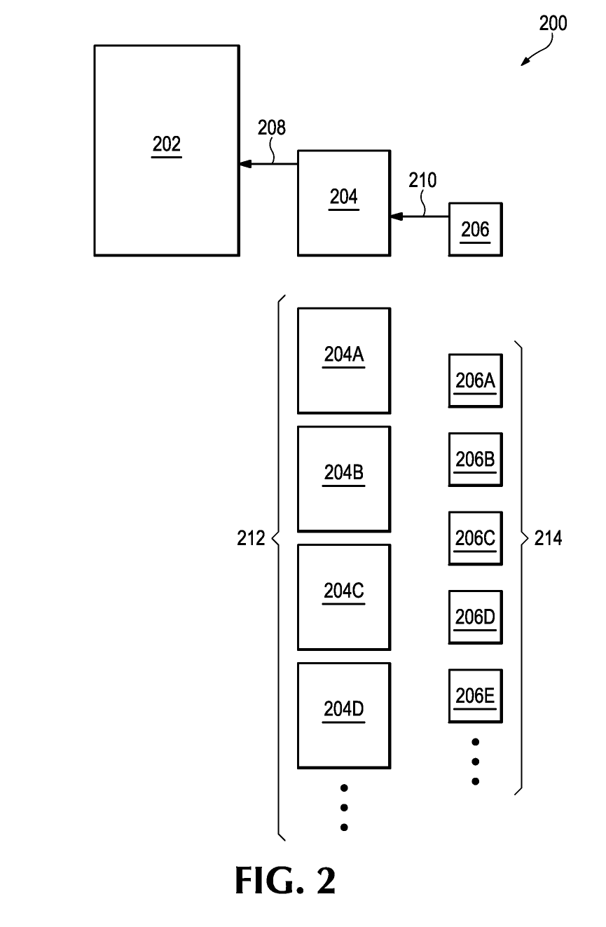

In various preferred embodiments, as shown in FIG. 2, a gas analyzer system 200 includes a handheld-sized gas analyzer test unit 202 with the features shown in FIG. 1, with the handheld unit 202 adapted to receive one or more sensor module 204, which in turn is adapted to receive one or more sensor chip 201. The handheld unit 202 preferably includes circuitry 208 for communicating with one or more different sensor modules 212, and each of the different sensor modules 212 (204A, 204B, 204C, 204D, . . . ) preferably includes circuitry 210 for receiving communicating with one or more different sensor chips 214 (206A, 206B, 206C, 206D, 206E, . . . ).

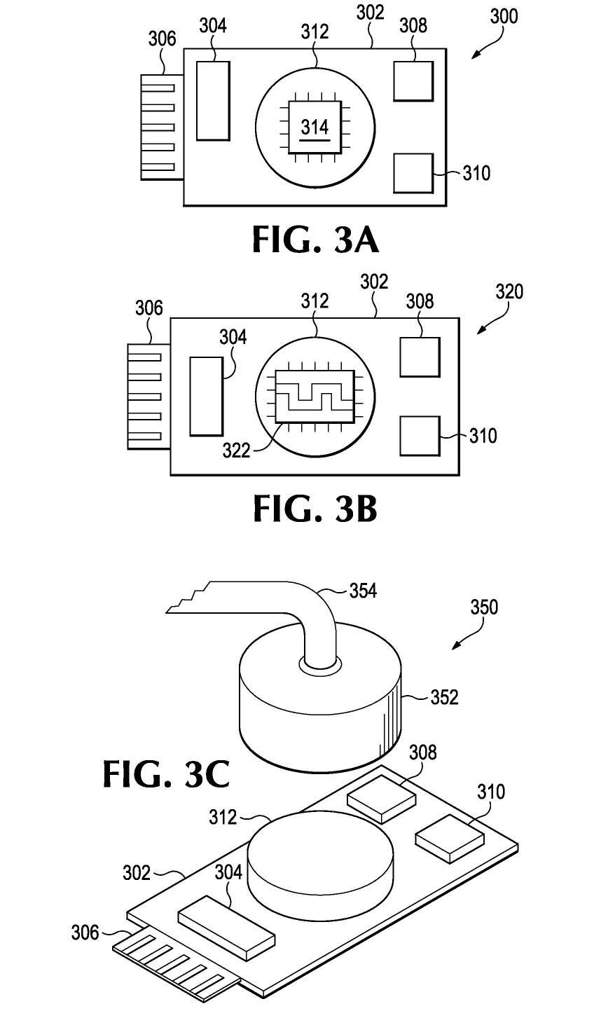

An exemplary sensor module 300 is shown in FIG. 3A, according to various preferred embodiments. As illustrated, the sensor module 300 includes a circuit board 302 with an area 312 for receiving a sampled gas to be analyzed and circuitry associated with a sensor chip 314. The sensor chip 314 is illustrated as a solid state/semiconductor type gas sensing integrated circuit/chip, according to one embodiment, but may comprise a different sensor technology. The sensor module 300 further includes, preferably, pins 306 for receiving power from a battery or other power supply circuitry associated with the analyzer unit within which the sensor module 300 is to be installed. Calibration information may be captured and stored in circuitry 304, circuitry/register 308 may be used for sensor status, history, and/or diagnostic information associated with the sensor 314, and circuitry 310 may be included to support other sensor functions and/or circuitry requirements specific to the particular technology of sensor chip 314.

In one embodiment, the calibration circuitry 304 may comprise dip switch settings, a conductive/capacitive/resistive network, or other circuitry representative of calibration setting and information set by a manufacturer, such as the manufacturer of the main gas analyzer instrument that receives the interchangeable, replaceable sensor modules. In one embodiment, the manufacturer provides the user with a pre-calibrated replacement sensor module that the user simply connects into the analyzer (such as by the connector pins 306 and any sample gas cap or tube as will be discussed below). Once installed in the analyzer unit, software in the analyzer preferably automatically interacts with the calibration circuitry 304 (and associated circuitry 308 and/or 310) to detect the replaced sensor module and automatically prepares the analyzer for use without any user interaction beyond plugging in the replacement sensor module.

FIG. 3B shows a sensor module 320 similar to that shown in FIG. 3A except with a different type of sensor chip 322. Sensor chip 322 may comprise a microchannel on silicon or other type of sensor on an integrated circuit/chip. The sensor chip may comprise a true integrated circuit combined with integral gas sensing structure and electronics. Alternatively, the sensor chip may comprise a conventional sensor mounted on a circuit board and adapted to be interchangeable with other similarly constructed “sensor chips” within the sensor module 320.

Additional structure, not shown, may be included with sensor chip 322 to sufficiently receive and expel sampled gas within the sample gas area 312. For example, FIG. 3C illustrates a perspective view of an exemplary sensor module 350 with associated sensor cap 352 and tube 354, according to a preferred embodiment. Sensor cap 354 is intended to represent sensor caps typically used with O2, CO, and other gas sensors (most commonly of the electrochemical type).

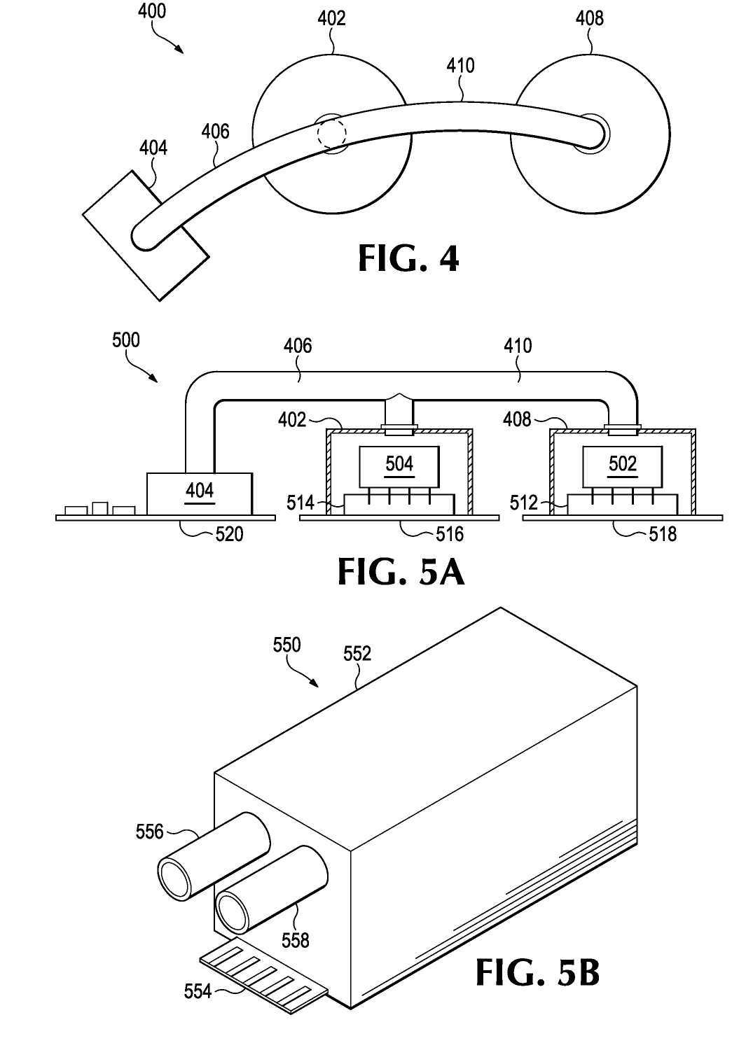

FIG. 4 is a top view of an exemplary arrangement 400 of sensors, according to some embodiments. The cap 408 shown in FIG. 4 may correspond to a cap associated with sampled gas area 312 in FIGS. 3A, 3B, and 3C. Sampled gas combustion analyzers may include CO and O2 sensors within sampled gas areas sealed under caps 408 and 402, respectively, with gas flow fan/motor/pump 404 and tubes 406 and 410, as shown.

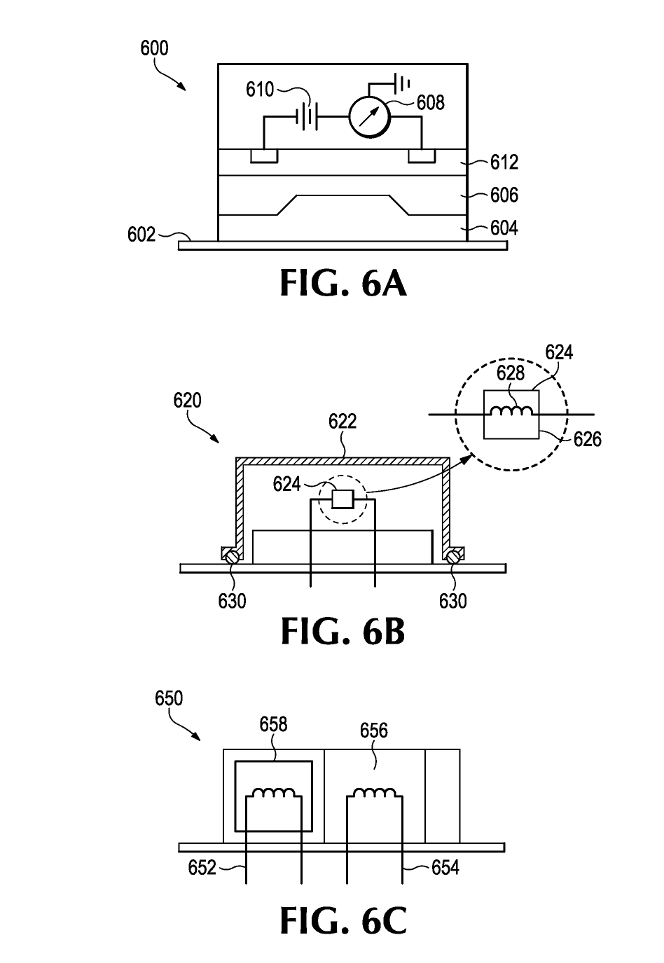

FIG. 5A is a side elevation view of an exemplary arrangement 500 of sensors, for example, the sensors shown in FIG. 4. Sensor 502 may be seated to circuit board 518, which when combined form a sensor module, in one embodiment. Sensor 504 may be seated to circuit board 516, which when combined form a second sensor module, in one embodiment. As shown, the caps 408 and 402 may fit downward over the sampled gas areas 512 and 514, respectively. The gas moving means 404 may be connected to circuitry 520 of a main gas analyzer unit, and, although not shown in FIG. 5A, each of the circuit boards 512 and 514 are preferably removably connected via pin connectors as shown in FIGS. 3A, 3B, and 3C to respective sensor module attachment points with the handheld gas analyzer unit.

In preferred embodiments, a sensor module 550 as shown in FIG. 5B comprises a housing 552 containing one or more sensor chips and having pin connector 554 for connection to circuitry of a handheld gas analyzer unit, and sampled gas supply 556 and return 558 lines. Other shapes and configurations for a sensor module 550 may be used.

In preferred embodiments, a field technician may carry different sensor modules, each module configured to detect and measure a particular type of gas, such as, for example, NOx (nitrogen oxide), CO2 (carbon dioxide), CO (carbon monoxide), NO (nitrogen monoxide), O2 (oxygen), CH5 (methane), C3H8 (propane), etc. Preferably, different sensor modules may be configured to detect a particular gas with different sensitivities, resolutions, and accuracies. For example, a particular sensor module may be equipped with a CO sensor capable of sensing CO within a range of zero to 2000 ppm, a resolution to 1 ppm, and an accuracy of +/−5 ppm, and another sensor module may be configured with a CO sensor capable of sensing within a range of zero to 8000 ppm, a resolution to 1 ppm, and an accuracy of +/−10 ppm. Also in preferred embodiments, different sensor modules may be configured and equipped with different sensor technologies so that the field technician may choose sensor modules for particular applications, compare sensor measurements using different types of sensor technologies, and more easily verify sampled gas test and measurement data.

Many different sensor technologies may be used. In preferred embodiments, sensor modules may accommodate different sensor chips each of which uses different sensing technologies, so that different sensing technologies may be used by swapping between sensor chips. In other preferred embodiments, sensor modules may incorporate different types of sensor technologies, so that different sensing technologies may be used by swapping between sensor modules used with the main gas analyzer instrument.

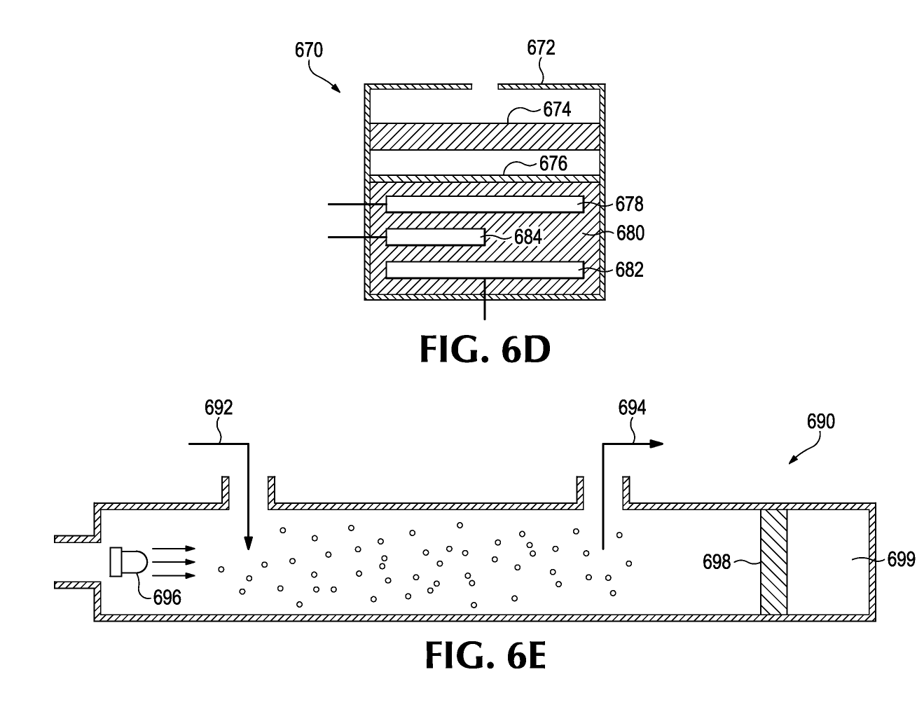

FIG. 6A is an illustration of an exemplary solid state type gas sensor 600 for use with a sensor module, according to some embodiments. The primary components include a circuit board 602, heater 604, silicon layer 606, metal oxide layer 612, voltage source 610, and meter 608.

FIG. 6B is an illustration of an exemplary catalytic (or Pellistor) type gas sensor 620 for use with a sensor module, according to some embodiments. Primary components include a protective can 622 (with an o-ring seals 630) within which the target sampled gas is oxidized on a catalytic element 624 comprising an aluminum bead 624 as the catalyst 626. As the sampled gas is oxidized the change in temperature causes a change in resistance in the platinum wire 628 that is then measured by the meter.

FIG. 6C is an illustration of an exemplary thermal conductivity type gas sensor 650 for use with a sensor module, according to some embodiments. Primary components include a reference element 652, sensing element 654, reference gas chamber 658, and sample gas sensing area 656.

FIG. 6D is an illustration of an exemplary electrochemical type gas sensor 670 for use with a sensor module, according to some embodiments. Primary components include a capillary diffusion barrier 672, (optional) scrubber filter 674 to filter out unwanted gases (commonly a charcoal filter), a gas permeable (or hydrophobic) membrane, electrolyte 680, sensing electrode 678, reference electrode 684, and counter electrode 682.

FIG. 6E is an illustration of an exemplary non-dispersive infrared (NDIR) type gas sensor 690 for use with a sensor module, according to some embodiments. Primary components include a cavity with sample gas inlet 692 and outlet 694, an infrared lamp 696, optical filter 698, and detector 699. Generally, a non-dispersive IR CO2 sensor may be used to measure CO2 by directing IR waves of light through a tube filed with sampled gas. The IR detector 699 measures the amount of IR light that hits it. As the sampled gas passes through the tube, gas molecules of the same size as the IR wavelength absorb the IR light and let other wavelengths of light pass through. The optical filter 698 absorbs wavelengths of light except the wavelength absorbed by CO2. The IR detector 699 then measures the amount of light not absorbed by the CO2 molecules or the optical filter. The difference between the amount of light radiated by the IR lamp 696 and the IR light received by the detector 699 is proportional to the number of CO2 molecules in the sampled gas passing through the tube.

Other types of gas sensors may be used with a sensor module, according to various embodiments. Other yet to be developed sampled gas sensors may be used with a sensor module, according to preferred embodiments.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A handheld sized combustion gas sampling analyzer comprising:
(a) a handheld sized housing;
(b) a display;
(c) a keypad or other user interface (such as, for example, a touch screen (that may be integral to (b)));
(d) a gas sample collecting means;
(e) a water trap and a filter;
(f) at least one removable sensor module;
(g) each of (f) adapted to receive at least one sensor chip; and
(h) circuitry adapted to receive sensing information from said (f) and said (g) thereon.

2. The unit of claim 1 further comprising a separate sensor module capable of replacing one of (f), wherein said separate sensor module is adapted for sensing a different type of sampled gas than any of (f).

3. The unit of claim 1 further comprising a separate sensor module capable of replacing one of (f), wherein said separate sensor module utilizes a different sensing technology than any of (f).

4. The unit of claim 1 further comprising a separate sensor chip capable of replacing one of (g) (sensor chip), wherein said separate sensor chip is adapted for sensing a different type of sampled gas than any of (g) (sensor chip).

5. The unit of claim 1 further comprising a separate sensor chip capable of replacing one of (g) (sensor ship), wherein said separate sensor chip utilizes a different sensing technology than any of (g) (sensor chip).

6. A handheld sized combustion gas sampling analyzer comprising:
(a) a handheld sized housing;
(b) a display;
(c) a keypad or other user interface (such as, for example, a touch screen (that may be integral to (b)));
(d) a gas sample collecting means;
(e) a water trap and a filter;
(f) at least one removable sensor chip; and
(g) circuitry adapted to receive sensing information from said (f).

7. The unit of claim 6 further comprising a separate sensor chip capable of replacing one of (f) (sensor chip), wherein said separate sensor chip is adapted for sensing a different type of sampled gas than any of (f) (sensor chip).

8. The unit of claim 6 further comprising a separate sensor chip capable of replacing one of (f) (sensor ship), wherein said separate sensor chip utilizes a different sensing technology than any of (f) (sensor chip).

9. A handheld sized combustion gas sampling analyzer comprising:
(a) a handheld sized housing;
(b) a display;
(c) a keypad or other user interface (such as, for example, a touch screen (that may be integral to (b)));
(d) a gas sample collecting means;
(e) a water trap and a filter;
(f) at least one removable sensor module; and
(g) circuitry adapted to receive sensing information from said (f).

10. The unit of claim 9 further comprising a separate sensor module capable of replacing one of (f), wherein said separate sensor module is adapted for sensing a different type of sampled gas than any of (f).

11. The unit of claim 9 further comprising a separate sensor module capable of replacing one of (f), wherein said separate sensor module utilizes a different sensing technology than any of (f).

12. A combustion gas sampling analyzer comprising:
(a) a housing;
(b) a gas sample collecting means;
(c) a water trap and a filter;
(d) at least one removable sensor module; and
(e) circuitry adapted to receive sensing information from said (d).

13. The unit of claim 12 further comprising a separate sensor module capable of replacing one of (d), wherein said separate sensor module is adapted for sensing a different type of sampled gas than any of (d).

14. The unit of claim 12 further comprising a separate sensor module capable of replacing one of (d), wherein said separate sensor module utilizes a different sensing technology than any of (d).

15. A combustion gas sampling analyzer comprising:
(a) a housing;
(b) a gas sample collecting means;
(c) a water trap and a filter;
(d) at least one removable sensor chip; and
(e) circuitry adapted to receive sensing information from said (d).

16. The unit of claim 15 further comprising a separate sensor chip capable of replacing one of (d), wherein said separate sensor chip is adapted for sensing a different type of sampled gas than any of (d).

17. The unit of claim 15 further comprising a separate sensor chip capable of replacing one of (d), wherein said separate sensor chip utilizes a different sensing technology than any of (d).

18. A method of using a sampled gas combustion analyzer comprising:
(a) collecting a sample of combustion gas;
(b) flowing said sample through an analyzer instrument comprising a removable and replaceable sensor module; and
(c) sensing a particular gas within said sample using said removable and replaceable sensor module.

19. The method of claim 18 further comprising:
(d) replacing said sensor module with another sensor module adapted to sense a second particular gas;
(e) collecting a second sample of combustion gas;
(f) flowing said second sample through said analyzer comprising said second sensor module; and
(g) sensing said second particular gas within said second sample using said second sensor module.

20. The method of claim 19 wherein at least one of said sensor module or said second sensor module comprises a removable and replaceable sensor chip.
